(19) United States
(12) Patent Application Publication
(10) Pub. No.: US 2010/0075612 A1
(43) Pub. Date: Mar. 25, 2010

(54) Advertising desired range in a wireless network

(76) Inventors: Emily H. Oi, Portland, OR (US); Marc Meylemans, Beaverton, OR (US); Oren Kaidar, Binyamina (IL)

Correspondence Address: INTEL CORPORATION;c/o CPA Global, P.O. BOX 52050, MINNEAPOLIS, MN, 55402, US

(21) Appl. No.: 12/284,211

(22) Filed: Sep. 19, 2008

(51) Int. Cl. H04B 17/00

(52) U.S. Cl. 455/67.13

(57) ABSTRACT

In various embodiments, a network device may transmit its desired proximity range in the form of a proximity information element (IE) in a beacon or a request frame. The IE may contain threshold values for a Receive Channel Power Indicator (RCPI) and a Receive Signal to Noise Indicator (RSNI). Only devices that receive the beacon or request frame with measured signal values at least as great as the RCPI and RSNI values will respond. Devices that receive the beacon or request frame with measured values less than the RCPI and/or the RSNI should not respond, thus reducing the volume of communications on the network at that time.

### BACKGROUND

In some conventional wireless networks, a device wishing to join a network may broadcast a request frame, measure the strength of the signals received from responding network controllers, and decide to join the network controlled by one of the responding network controllers. However, in very dense network environments, the number of responding controllers may be so large that the networks can become overburdened with the volume of traffic.

### BRIEF DESCRIPTION OF THE DRAWINGS

Some embodiments of the invention may be understood by referring to the following description and accompanying drawings that are used to illustrate embodiments of the invention. In the drawings:

FIG. 1 shows a diagram of two overlapping networks, according to an embodiment of the invention.

FIG. 2 shows a format of a proximity information element, according to an embodiment of the invention.

FIG. 3 shows a communications exchange between a network controller and a wireless device that may try to associate with the controller, according to an embodiment of the invention.

FIG. 4 shows a communications exchange between two wireless devices, according to another embodiment of the invention.

FIG. 5 shows a flow diagram of a method of handling a communication requesting a reply, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Various embodiments of the invention may be implemented in one or any combination of hardware, firmware, and software. The invention may also be implemented as instructions contained in or on a computer-readable medium, which may be read and executed by one or more processors to enable performance of the operations described herein. A computer-readable medium may include any mechanism for storing, transmitting, and/or receiving information in a form readable by one or more computers. For example, a computer-readable medium may include a tangible storage medium, such as but not limited to read only memory (ROM); random access memory (RAM); magnetic disk storage media; optical storage media; a flash memory device, etc. A computer-readable medium may also include a propagated signal which has been modulated to encode the instructions, such as but not limited to electromagnetic, optical, or acoustical carrier wave signals.

The term “wireless” and its derivatives may be used to describe circuits, devices, systems, methods, techniques, communications channels, etc., that communicate data by using modulated electromagnetic radiation through a non-solid medium. The term does not imply that the associated devices do not contain any wires, although in some embodiments they might not. The term “mobile” wireless device is used to describe a wireless device that may be in motion while it is communicating.

In various embodiments of the invention, a wireless communications device may transmit a request for other devices to reply to it, and potentially limit the devices that should reply by including a threshold requirement for the signal strength and signal-to-noise ratio (SNR) seen by those replying devices. Devices that receive the request with a measured signal strength or SNR that is less than the threshold value should not reply to the request. Devices that receive the request with a measured signal strength and SNR that exceed the threshold values may reply to the request. Such requests may include, but are not limited to, such things as a beacon, a probe request, or an action frame. The threshold values may be defined in an information element (IE) included in the requesting transmission. The IE may be included in a transmission from either a network controller (only devices that receive a sufficiently good signal should reply by requesting association with the network controller), or in a transmission from a mobile stations (MS) wishing to associate with a network controller (only network controllers that receive a sufficiently good signal should permit the MS to associate with them). Within the context of this document, the term “associated” refers to two wireless network devices establishing an agreed-upon temporary communications relationship with each other, such that they may communicate with each other following specific rules of format, protocol, timing, and frequency(s). In most such associations, one of the devices is a network controller and controls when the other may communicate with it.

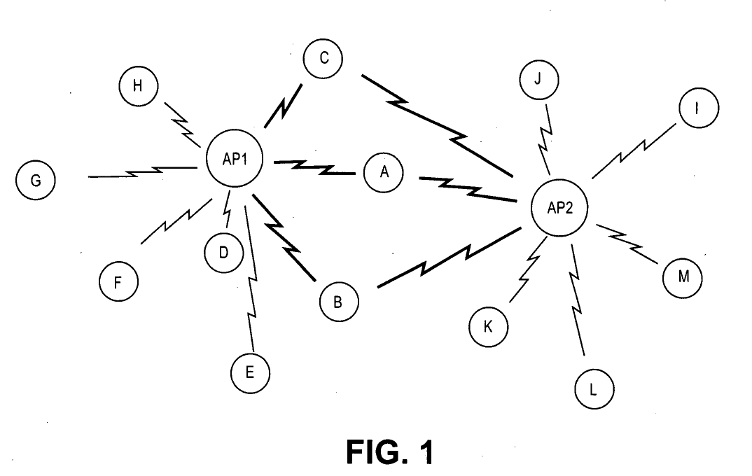

FIG. 1 shows a diagram of two overlapping networks, according to an embodiment of the invention. In the illustrated embodiment, two access points AP1 and AP2 may act as network controllers for various ones of the wireless mobile stations (MS) A-M. Although the network controllers may be labeled herein as APs, a term commonly used in wireless local area networks (WLAN), in other embodiments they might be any other type of network controllers, such as but not limited to base stations (BS), or piconet controllers (PNC). Similarly, although the devices A-M are referred to here as mobile stations (MS), this term is also for convenience of reference. In other embodiments, they may be any other type of wireless network device whose communications are subject to regulation by a network controller, such as but not limited to devices commonly referred to as a STA, or a subscriber stations (SS).

Although not specifically illustrated, each of the AP's and each of the MS's may include one or more antennas, and each of the MS's may include a battery to provide operational power to the device. In some embodiments, each of the AP's may also include a battery to provide operational power.

When a MS wishes to join a network by becoming associated with the network controller, it may be close enough to several AP's to join any of their networks. In the simplified situation of FIG. 1, each of the three MS's A, B, and C may be considered close enough to both AP1 and AP2 to join either network. (The other devices D-M may be assumed to be associated with one of AP's I or 2, with another AP not shown, or not associated with any AP. The specific association status of these other MS's is not considered important to an understanding of the described embodiments of the invention.) In conventional networks, each of mobile stations A, B, and C might respond to a beacon from AP1. Similarly, both AP1 and AP2 might respond to a probe request by mobile station A. If this simplified example is expanded so that several AP's are within communication range of device A, or many unassociated MS's are within communication range of AP1, there might be many responses to the beacon or to the probe request. The resulting increase in network traffic could bog down both the overall network throughput and the work load of individual AP's and MS's, as well as increasing the likelihood of interference within the networks.

However, the techniques described herein may be used to prevent some of the AP's or the MS's from responding, so that this overload may be reduced or avoided. When AP1 sends out a beacon, these techniques may be used to prevent at least one of the MS's A, B, and C from responding to the beacon. Similarly, when MS A sends out a probe request, these techniques may be used to prevent AP1 or AP2 from responding. In both cases, the strength and quality of the signal of the beacon or probe request may be the deciding factor in which devices respond and which do not.

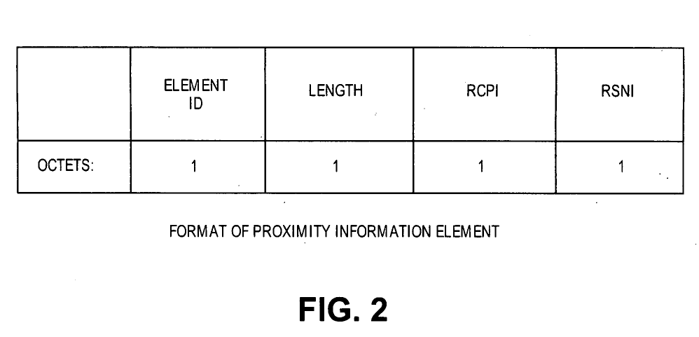

FIG. 2 shows a format of a proximity information element, according to an embodiment of the invention. The term “proximity”, as used herein, is used to distinguish this type of IE from the many other types of IE's that currently exist or will be created. However, the common definition of “proximity”, which involves relatively close physical separation, should not be read as a limitation on the use or purpose of this IE. Some of the contents of the proximity IE may indicate values for two parameters that might be greater, under certain circumstances, between devices that are closer together, and less when those devices are farther apart. However, due to variable conditions that might exist, such as intervening obstructions, signal reflections, variation in transmission power from different devices, etc., stronger values for either or both of these parameters may not correspond exactly to closer physical distance between devices. However, the term ‘proximity IE’ will continue to be used here as a general label, because larger values of these parameters may generally, though not always, imply lesser physical distance between the transmitter and receiver.

The IE shown in FIG. 2 contains four fields, though other embodiments may differ in the number of fields, their order, and their meaning. The IE shown contains four octets, for a total of 32 bits, with each field being one octet in length, though other embodiments may differ in this respect. The illustrated IE contains standard portions, such as an element ID field to distinguish what type of IE this is, and a length field to define how long the IE is. It also contains two fields that are pertinent to this particular type of IE. The field RCPI indicates a value for Received Channel Power Indicator. Similarly, the RSNI field indicates a value for Received Signal-to-Noise Indicator. In some embodiments, a particular value in either or both of these fields (e.g., all 1's, or alternately, all 0's) may indicate that the comparison of a measured value with the contents of this field is not to be made.

RCPI and RSNI values contained in this proximity IE represent threshold values, against which corresponding measured values may be compared. Whenever this IE is included in a transmission, and contains valid threshold values, a device receiving the transmission may measure the power of the received signal for that transmission, and measure the signal-to-noise ratio of the received signal for that-transmission, and compare those measured values against the corresponding RCPI and RSNI values in the IE. If the measured values for both parameters are greater than the corresponding values in the IE, then the receiving device may reply to the transmission. If one or both measured values is smaller than the corresponding value in the IE, then the receiving device may not reply to the transmission. If either measured value is equal to the indicated value in the IE, it may be interpreted as greater than or less than the indicated value, depending on the particular convention being used. Either convention should be interpreted as falling within the scope of the embodiments of the invention.

Of course, there may be other reasons why the receiving device might choose not to respond even if the measured values are greater than the indicated values, or to respond even if one or both of the measured values are less than the indicated values. Those exceptions are not addressed here and are not considered part of the embodiments of the invention.

When this process is used by each of multiple wireless devices in an area, and they all receive the same transmission, then only those that receive the signal strongly and clearly (as determined by the above comparisons) will respond to the transmission. This effectively prevents those devices that receive a weak/poor signal from trying to respond. When this technique is used with association activities, the effect is to only permit those devices that can communicate clearly/strongly with each other to engage in the association process. The other devices (which would probably not be candidates for association anyway) will not clog up the network with unnecessary communications. MS's that are currently unassociated with any AP may use the described process to identify a desirable candidate AP to become associated with. Similarly, MS's that are already associated with another AP may use the described process to respond to a beacon from this AP if it seems that changing to this AP is feasible and potentially desirable.

In some embodiments, the values of RCPI and/or RSNI in the IE may be changed dynamically. For example, in a very crowded network environment with numerous networks overlapping each other, comparatively high values of RCPI/RSNI may be used to reduce the number of respondents to a beacon or probe request. Similarly, the values of RCPI/RSNI may be modified to change the physical size of the coverage area of the network. Further, different nearby AP's may use different values of RCPI/RSNI in their beacon to influence load balancing between the networks. For example, an AP with relatively few MS's in its network may use lower values of RCPI and/or RSNI in its beacon to encourage more MS's to try to associate with it, while an AP with many MS's in its network may use higher values of RCPI and/or RSNI in its beacon to discourage more MS's from trying to associate with it. To facilitate this cooperation, the AP's may communicate with each other to exchange information on current network loads and RCPI/RSNI values.

Although the previous description was presented in terms of communication between network controller(s) and non-controller device(s), the same techniques may be used in peer-to-peer communications, where neither device will assume the function of network controller.

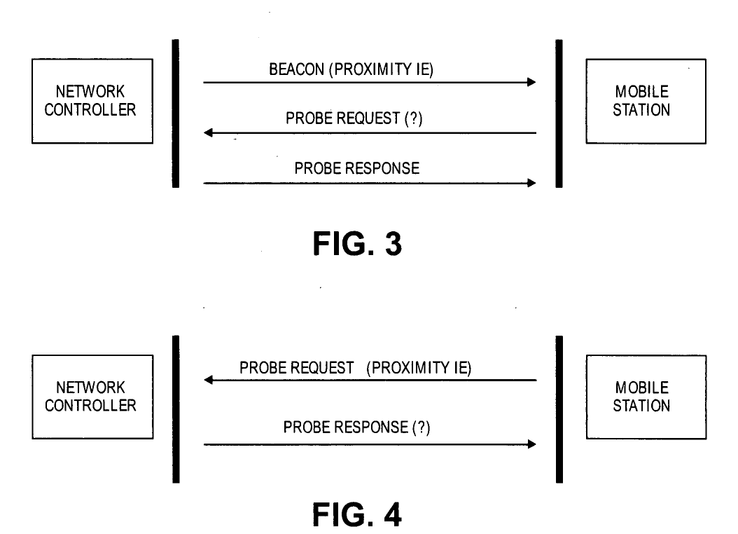

FIG. 3 shows a communications exchange between a network controller and a wireless device that may try to associate with the controller, according to an embodiment of the invention. In the illustrated embodiment, the network controller may transmit a beacon containing the proximity IE. Beacons may serve various purposes in a wireless network, such as synchronizing the clocks in the various devices in the network. Another purpose may be an invitation for devices to communicate a request to become associated with this network controller. For this purpose, the contents of the proximity IE may place some limits on which devices may make such a request. If the device receiving the beacon (in this case an MS) determines that the received signal does not meet the requirements for RCPI or RSNI, it may not respond, in which case the illustrated probe request and probe response will not take place. However, if the received signal does meet the requirements for RCPI and RSNI, the MS may reply with a probe request. The network controller may then transmit a probe response, and further communications between the two devices may result. For the purposes of this document, the nature of these further communications may be unimportant, since we are concerned here with the transmission containing the proximity IE and the reply, or lack of reply, to that transmission.

FIG. 4 shows a communications exchange between two wireless devices, according to another embodiment of the invention. In this case, the proximity IE is contained in the probe request, and whether a probe response is transmitted depends on whether the received signal for the probe request meets the requirements for RCPI and RSNI, as specified in the proximity IE. In FIG. 4 the device transmitting the probe request is attempting to reduce the potential number of devices that may reply to the probe request by transmitting a probe response, whereas in FIG. 3 the device transmitting the beacon is attempting to reduce the potential number of devices that may reply to the beacon by transmitting a probe request. But in both cases, the results may be to make the network smaller, either in physical coverage area or in number of devices. These two examples differ over the point of the communications exchange at which the proximity IE is transmitted, and in some cases, over the types of devices that might transmit it.

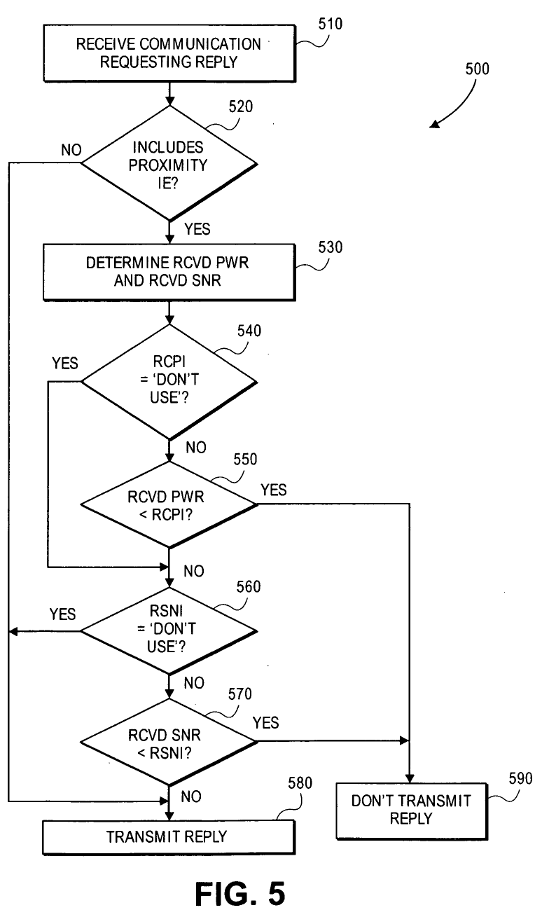

FIG. 5 shows a flow diagram of a method of handling a communication requesting a reply, according to an embodiment of the invention. In flow diagram 500, at 510 a wireless communication device may receive a transmission requesting any receiving devices, if they choose, to transmit a reply to the requesting device. For the purposes of this description, this request is limited to only those types of requests that might result in replies from multiple receiving devices. A targeted request to a single, specific device is not included here. In particular, examples include a beacon, to which multiple devices wishing to associate with the transmitting device may reply with a probe request, and unsolicited probe requests, to which network controllers or peer devices may reply with a probe response.

At 520, the received transmission is examined to determine if it contains a proximity IE. If not, at 580 the device may reply in the manner it normally would if the various embodiments of this invention did not exist. However, if the received transmission does contain the proximity IE, the device may examine the signal of the received transmission and measure values for received power and received signal-to-noise ratio for that signal at 530. Note: although this determination operation is shown as occurring after 520, in some embodiments the device may make these measurements, and make this determination, before, during, or after operation 520. In some embodiments, the device may make these measurements for other reasons, regardless of whether there is a proximity IE in the transmission.

Once these parameters have been determined, and the existence of the proximity IE has been verified, the values of RCPI (at 540) and RSNI (at 560) from the IE may be examined to determine if either has a default value that indicates “don't use this parameter for comparisons”. If both indicate “don't use”, the flow may move to 580 where the reply is transmitted in the normal manner. However, if either the measured value for received power is less than the value of RCPI (as determined at 550), or the measured value for received signal-to-noise ratio is less than the value of RSNI (as determined at 570), then the reply will not be transmitted, as indicated at 590. As previously noted, some embodiments may have the ability to override the decision process described here, and either transmit or not transmit the reply based on other reasons not considered here. These exceptions are ignored in the circumstances described by flow diagram 500.

The foregoing description is intended to be illustrative and not limiting. Variations will occur to those of skill in the art. Those variations are intended to be included in the various embodiments of the invention, which are limited only by the spirit and scope of the following claims.

What is claimed is:

1. An apparatus, comprising
a first wireless communications device, the first device to:
receive a transmission from a second wireless communications device, the transmission comprising a first value for a receive channel power indicator (RCPI) and a second value for a receive signal to noise indicator (RSNI);
measure an actual RCPI value for a signal of the received transmission;
measure an actual RSNI value for the signal of the received transmission;
reply to the received transmission if the actual RCPI value is greater than the first value and the actual RSNI value is greater than the second value; and
not reply to the received transmission if the actual RCPI value is less than the first value or the actual RSNI value is less than the second value.

2. The apparatus of claim 1, wherein the first value and the second value are to be included in an information element in the transmission.

3. The apparatus of claim 2, wherein the received transmission is to include a beacon containing the information element.

4. The apparatus of claim 2, wherein the received transmission is to include a probe request containing the information element.

5. The apparatus of claim 2, wherein the received transmission is to include an action frame containing the information element.

6. The apparatus of claim 1, wherein the apparatus comprises a network controller for communicating in a wireless network.

7. The apparatus of claim 1, wherein the apparatus comprises a mobile station for communicating in a wireless network.

8. The apparatus of claim 1, wherein the first wireless communications device includes a battery to provide operational power to the wireless communications device.

9. A method, comprising:
receiving a wireless transmission from a wireless communications device, contents of the transmission comprising a first value for a receive channel power indicator (RCPI) and a second value for a receive signal to noise indicator (RSNI);
measuring an actual RCPI value for a signal of the received transmission;
measuring an actual RSNI value for the signal of the received transmission;
replying to the received transmission if the actual RCPI value is greater than the first value and the actual RSNI value is greater than the second value; and
not replying to the received transmission if the actual RCPI value is less than the first value or the actual RSNI value is less than the second value.

10. The method of claim 9, wherein the first value and the second value are included in an information element in the transmission.

11. The method of claim 9, wherein the received transmission includes a beacon containing the first and second values.

12. The method of claim 9, wherein the received transmission includes a probe request containing the first and second values.

13. The method of claim 9, wherein the received transmission includes an action frame containing the first and second values.

14. The method of claim 9, wherein the wireless communications device comprises a network controller.

15. The method of claim 9, wherein the wireless communications device comprises a mobile wireless communications device.

16. An article comprising a tangible computer-readable medium that contains instructions, which when executed by one or more processors result in performing operations comprising:
receiving a wireless transmission from a wireless communications device, contents of the transmission comprising a first value for a receive channel power indicator (RCPI) and a second value for a receive signal to noise indicator (RSNI);
measuring an actual RCPI value for a signal of the received transmission;
measuring an actual RSNI value for a signal of the received transmission;
replying to the received transmission if the actual RCPI value is greater than the first value and the actual RSNI value is greater than the second value; and
not replying to the received transmission if the actual RCPI value is less than the first value or the actual RSNI value is less than the second value.

17. The article of claim 16, wherein the operation of receiving comprises receiving the first value and the second value in an information element in the transmission.

18. The article of claim 16, wherein the operation of receiving comprises receiving a beacon containing the first and second values.

19. The article of claim 16, wherein the operation of receiving comprises receiving a probe request containing the first and second values.

20. The article of claim 16, wherein the operation of receiving comprises receiving an action frame containing the first and second values.

21. The article of claim 16, wherein the operation of receiving comprises receiving the wireless transmission from a network controller.

22. The article of claim 16, wherein the operation of receiving comprises receiving the wireless transmission from a mobile wireless communications device.
